(19) United States
(12) Patent Application Publication
(10) Pub. No.: US 2001/0014430 A1
(43) Pub. Date: Aug. 16, 2001

(54) Spectrally selective layer and optical component for same

(76) Inventor: Martin Dubs, Maienfeld (CH)

Correspondence Address: NOTARO AND MICHALOS, 100 DUTCH HILL ROAD, SUITE 110, ORANGEBURG, NY, 10962-2100, US

(21) Appl. No.: 09/735,722

(22) Filed: Dec. 7, 2000

Related U.S. Application Data
(63) Continuation of application No. PCT/CH99/00233, filed on May 31, 1999.

(30) Foreign Application Priority Data
Jun. 10, 1998 (CH) 1257/98

(51) Int. Cl. G11B 7/24

(52) U.S. Cl. 430/270.13; 428/64.4; 428/913; 430/945; 428/914; 369/275.2; 369/275.5

(57) ABSTRACT

A layer arrangement for an optical component or an optical data storage element such as a CD, a DVD, a hybrid disk or a super audio disk, has at least one layer which is at least predominantly Si₍₁₋ₓ₎Ge₍ₓ₎H_{y} as a spectrally selective layer for a predominant reflection of light in a lower part of a spectral range of 600 nm to 800 nm and for a predominant transmission of light in an upper part of said spectral range. The values for x and y are 0.1<x≦0.9 and 0≦y≦0.5.

### CROSS-REFERENCE TO RELATED APPLICATION

This is a continuation application of International Application PCT/CH99/00233, filed May 31, 1999 and claims priority on Swiss application 1257/98 filed Jun. 10, 1998.

### FIELD AND BACKGROUND OF THE INVENTION

The present invention builds on the demands for optical data stores in which information is provided in two planes, each through local modulation of reflection determining physical parameters. Such optical data stores, such as optical CD, DVD, hybrid disks or super audio disks with high data packing density are applied in two technologies. In the case of the one, which is extensively discussed in EP-A-0 762 406, laser light of one wavelength is reflected on the first plane corresponding to the data modulated upon there. A portion of this light is transmitted to the second plane and only there reflected corresponding to the data modulated upon there. In the case of the second technique laser light of two given wavelengths is directed onto the store. The light of the one wavelength is reflected on the first plane, modulated correspondingly and largely reflected, while the light of the second wavelength is largely transmitted and only reflected in a second plane corresponding to the data modulated upon there. The present invention relates to the second technique.

### SUMMARY OF THE INVENTION

The object of the present invention is finding a spectrally selective layer which selectively reflects or transmits light in each instance from the lower and the upper spectral range of 600 nm to 800 nm, satisfying the requirements in the case of optical data stores.

The requirements, for example in the case of hybrid disks or super audio disks are that laser light of wavelength 650 nm must be reflected on the first plane at 18 to 30%, whereas light of the second wavelength, at 780 nm, at least to 90% is transmitted at this plane in order to exit again with at least 65 to 70% intensity after reflection on a further plane.

Furthermore, according to the object, it should be possible to manufacture this layer cost-effectively, with conventional vacuum coating processes, in particular by means of reactive or non-reactive sputter coating, and the layer material should be relatively cost-effective. According to the invention such a spectrally selective layer is realized at least predominantly of the material

Si₍₁₋ₓ₎Ge₍ₓ₎H_{y}

with

0.1<x≦0.9,

0≦y≦0.5.

Germanium, as a relatively cost-effective semiconductor material, also has, in the spectral range between 600 nm and 800 nm, a sharp absorption edge of its absorption behavior. This absorption edge causes a change of the index of refraction in the range from 600 nm to 800 nm.

The index of refraction, which is markedly increased at the shorter wavelength, yields even for thin layers (approximately 10-30 nm) a sufficiently high reflection, while at higher wavelengths the reflection decreases strongly. The suitable selection of x and y ensures that the absorption edge at the higher wavelength is not noticeable to a disturbing extent.

This results in the light from the lower range or spectral band of the stated spectral range being reflected at the layer, and light from the upper spectral band being transmitted through the layer. Since the absorption of pure germanium in the upper band of the stated spectral range is too high, it is proposed to reduce it by providing an Si₍₁₋ₓ₎Ge₍ₓ₎ alloy and therein adjusting the spectral conditions for the specifically selected light wavelengths by variation of the stoichiometric mass x. A further reduction of the absorption, be that on germanium or be that on the Si—Ge alloy, is preferably attained by adding hydrogen.

The various features of novelty which characterize the invention are pointed out with particularity in the claims annexed to and forming a part of this disclosure. For a better understanding of the invention, its operating advantages and specific objects attained by its uses, reference is made to the accompanying drawing and descriptive matter in which a preferred embodiment of the invention is illustrated.

### BRIEF DESCRIPTION OF THE DRAWINGS

In the drawings:

FIG. 1 is a schematic diagram of the layers for use as an optical storage element according to the present invention.

### DESCRIPTION OF THE PREFERRED EMBODIMENTS

The layer according to the invention is used in particular for the spectrally selective application with light wavelengths of 650 nm±10% and 780 nm±10%. Silicon and germanium can be alloyed optionally, thus allowing sputter targets for the deposition of the layer according to the invention to be produced cost-effectively. By sputtering silicon/germanium alloy targets in a hydrogen-containing atmosphere, selection of said stoichiometric mass x in respect to the alloy and of the partial pressure of hydrogen in the sputtering atmosphere, the deposited layer is tailored for the wavelengths to be treated spectrally differently.

Moreover, according to the invention an optical component, in particular a storage element with information storage in two planes, with the spectrally selective layer according to the invention is proposed. In a preferred embodiment of the optical storage element, said layer is disposed bilaterally in contact against identical material, in particular against polycarbonate.

The layer according to the invention is in particular suitable for CD, DVD, hybrid disk or super audio disk storage elements, wherein, spaced apart from said layer, according to the invention a reflection layer is provided thereon, preferably a metal layer.

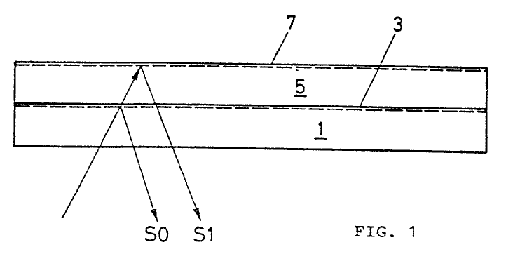

FIG. 1 schematically depicts an optical storage element according to the invention of said type. It comprises a 0.6 mm thick polycarbonate stratum 1, the spectrally selective layer 3 according to the invention, followed by a further approximately 0.6 mm thick polycarbonate stratum 5 and a reflection layer 7, preferably a metal layer such as an Al or Ag layer. On such a structure at 650 nm a reflection corresponding to Sₒ within the required specification of more than 18% was attained, as well as an intensity of the beam Sᵢ at 780 nm above 70%.

For the purpose of this disclosure the term “at least predominantly of Si₍₁₋ₓ₎Ge₍ₓ₎H_{y}” is intended to means at least 50% by weight and up to 100% by weight Si₍₁₋ₓ₎Ge₍ₓ₎H_{y}.

While specific embodiments of the invention have been shown and described in detail to illustrate the application of the principles of the invention, it will be understood that the invention may be embodied otherwise without departing from such principles.

What is claimed is:

1. A layer arrangement comprising at least one layer which is at least predominantly Si₍₁₋ₓ₎Ge₍ₓ₎H_{y} as a spectrally selective layer for a predominant reflection of light in a lower part of a spectral range of 600 nm to 800 nm and for a predominant transmission of light in an upper part of said spectral range, wherein:
0.1<x≦0.9
0≦y≦0.5.

2. A layer arrangement according to claim 1, adapted for light in the lower part of the spectral range being 650 nm±10% and light in the upper part of the spectral range being 780 nm±10%.

3. A layer arrangement according to claim 1, wherein the layer has a thickness between about 10 and 30 nm inclusive.

4. A spectrally selective optical component having a spectrally selective layer for a predominant reflection of light in a lower part of a spectral range from 600 nm to 800 nm and for a predominant transmission of light in an upper part of said spectral range, wherein the layer comprises at least predominantly:
Si₍₁₋ₓ₎Ge₍ₓ₎H_{y} with
0.1<x≦0.9 and
0≦y≦0.5.

5. An optical data storage element with information storage in at least two spaced apart planes, comprising: in one of the two planes, a layer comprising
Si₍₁₋ₓ₎Ge₍ₓ₎H_{y} with
0.1<x≦0.9
0≦y≦0.5; and
in the other of the two plane, a reflection layer.

6. An optical data storage element according to claim 5, wherein the spectrally selective layer is on both of its sides embedded in the same material.

7. An optical data storage element according to claim 5, wherein the element is one of; a CD, a DVD, a hybrid disk or a super audio disk.

8. An optical data storage element according to claim 5, wherein the reflection layer is metal.

9. An optical data storage element according to claim 6, wherein said same material is polycarbonate.
